(19) United States
(12) Patent Application Publication
(10) Pub. No.: US 2011/0202467 A1
(43) Pub. Date: Aug. 18, 2011

(54) AUTOMATED LOAD CONTROL AND DISPATCH SYSTEM AND METHOD

(76) Inventors: Del A. Hilber, Bel Air, MD (US); John Petze, Keswick, VA (US); Anno Scholten, Grapevine, TX (US); Leighton J. Wolfe, Lexington, MA (US); Peter Kelly-Detwiler, Scituate, MA (US)

(21) Appl. No.: 13/008,551

(22) Filed: Jan. 18, 2011

Related U.S. Application Data
(60) Provisional application No. 61/296,244, filed on Jan. 19, 2010.

(51) Int. Cl. G06Q 20/00; G06F 1/32

(52) U.S. Cl. 705/80; 700/296

(57) ABSTRACT

A group of electronic circuit logic blocks work together to receive a load control event message and respond thereto. A display is generated for a customer that includes (1) a set of plural load control scenarios that can be selected to respond to the load control event message and (2) an amount of reduction associated with selected load control scenarios of the plural load control scenarios that were selected in response to the load control event message. The display may also include a monetary value of the amount of reduction associated with the selected load control scenarios of the plural load control scenarios that were selected in response to the load control event message. An electronic commitment message is sent in response identifying an amount the customer will reduce a load at a time specified in the load control event message.

### CROSS-REFERENCE TO RELATED APPLICATIONS

The present application claims priority to co-pending U.S. Provisional Patent Application Ser. No. 61/296,244, filed Jan. 19, 2010, the contents of which are incorporated herein by reference. The present invention is related to (1) application Ser. No. 11/889,706, entitled “Energy usage prediction and control system and method,” (2) application Ser. No. 11/889,633, entitled “Multi-Input Building Controller and (3) application Ser. No. 11/889,632, entitled “Multi-building control for demand response power usage control,” now U.S. Pat. No. 7,565,227. All of those applications were filed on Aug. 15, 2007 and are incorporated herein by reference.

### FIELD OF THE INVENTION

The present invention is directed to a method and system for controlling energy usage in response to certain events, and in one embodiment to a method and system that enables one of a set of customer-approved energy saving techniques to be applied by an energy-based company requesting that an energy saving technique be activated.

### BACKGROUND OF THE INVENTION

Electrical power control can be divided into several distinct processes: generation, transmission (including independent service operators), distribution and supply (wholesale and retail). Each of these processes can potentially be provided by a different energy company or service provider. However, each such company cannot operate in a vacuum as the amount of power generated must match the amount of power consumed. Moreover, since the amount of power that can be generated at any point in time is finite, there are cost considerations with requiring (and therefore buying) additional electricity without advanced notice. Typically in high demand times, the cost of buying electricity in the spot market (i.e., short-term market) is higher than had the electricity been purchased in advance such that additional generation could have been planned in advance.

By agreeing to lower energy usage when called upon, the owners or managers of the buildings receive a preferential energy rate from the energy company. Such a preferential rate may be in the form of a fixed rate reduction or a variable rate reduction. Fixed rate reductions include, but are not limited to, a fixed reduced rate for the year, a fixed reduced rate for the month(s) that the building(s) reduced energy usage on demand, a fixed reduced rate for the day(s) that the building(s) reduced energy usage on demand, a fixed rate for the hours that the buildings reduced energy usage on demand. For example, if a building would be able to contract for $0.019/kW hr for its energy usage over the whole year, it may instead be able to contract for $0.018/kW hr for its energy usage over the whole year if it agrees to reduce its energy usage on demand (whether it ever is called on to reduce demand or not). Alternatively, the building may instead be able to contract for $0.0185/kW hr for its energy usage over the whole year if it agrees to reduce its energy usage on demand plus it receives a rebate of $100/month or $10/day for each month or day that it actually reduces energy usage on demand. Other fixed reductions are also possible.

Variable rate reductions include, but are not limited to, a sharing of the percentage of the cost that the energy company would have otherwise incurred had the building not reduced its energy usage. For example, if during a peak demand time the energy company would have had to purchase $100 more of electricity in the market had the building not reduced its energy usage, and instead the energy company only had to buy $20 of electricity, the energy company could provide the building with a $40 credit or payment representing half of the energy company's savings. Similarly, if a building has reduced energy needs (and therefore excess energy available compared to previous predictions), the building may sell its excess capacity to the energy company for a percentage (e.g., 75%) of what the energy company can obtain for it in the market. Other percentages and variable rates are also possible. The energy company could likewise utilize a combination of fixed and variable rate reductions, and/or customer credits or payments in order to better suit its or its customers' needs.

### BRIEF DESCRIPTION OF THE DRAWINGS

The following description, given with respect to the attached drawings, may be better understood with reference to the non-limiting examples of the drawings, wherein:

FIG. 1 is a block diagram showing the interaction between various logical levels of components that implement one aspect of the invention;

FIG. 2 is a block diagram of interactions between various computers at the different logical levels of FIG. 1;

FIG. 3 is a screenshot of a web interface for providing information to a customer about energy usage, including an electronic notification that the energy manager is requesting that a customer reduce the customer's energy load/usage at a specified time;

FIG. 4 is a screenshot of a web interface for providing information to a customer about the value of energy reductions being requested and the corresponding load control scenarios that achieve those savings; and

FIG. 5 is a block diagram of an exemplary logic block for implementing one set of control signals to be sent to a Building Automation System (BAS) based on one set of inputs.

### GLOSSARY

As would be understood by those skilled in the art, there are a number of acronyms understood by those in the power generation/distribution field. A list of several of those acronyms is provided below.
BAS: Building Automation System
DE: Decision Engine
DR: Demand Response
LCU: Load Control Unit
UI: User Interface

### DISCUSSION OF THE PREFERRED EMBODIMENTS

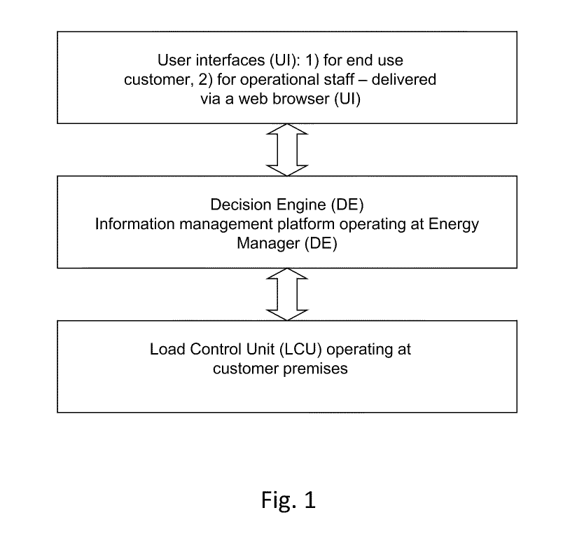

Turning to FIG. 1, multiple logical levels/layers (e.g., the UI, DE and LCU levels/layers) of components (e.g., hardware and/or software implemented as electronic circuit logic blocks (described more fully below)) can interact (e.g., by sending messages therebetween and by providing control interfaces, such as web-based interfaces, for requesting parameter changes between levels) as described below. The User Interface (UI) layer/level can provide visualization of information to the end customer to enable them to interact with the system and understand the status and value of load control activities. Features can include: (1) a customer Graphical User Interface providing a view of the requested load shed amount, the dollar value of participating at that (or other levels of load response), and a tool to choose which load control scenarios will be activated, (2) Real time information displays (e.g., using animated widgets), (3) Reports (e.g., using charts and tabular displays and/or provided in PDF and CSV formats), and (4) Notifications (e.g., using chat-type messaging techniques, email, pager, Twitter, etc.). The User Interface Level can further be supplemented with an Administrative User Interface which allows control of parameters and retrieving of data that is specific to administrative functions of the system (as opposed to customer-specific functions).

The Decision Engine (DE) Layer/Level (also sometimes referred to as a Central Decision Engine (CDE)) provides the main level of coordination and management. It can generate and serve the UI displays (e.g., by generating and sending an HTML- or DHTML-interface to a client web browser) and provide functions including: (1) Enterprise interfaces to external applications such as (a) Weather feeds, (b) Commodity Pricing, (c) Maps, (d) Messaging and email, (e) Databases and (f) User directories. The DE Level can also communicate with Local Control Units to handle commissioning, programming, load control event initiation, and status reporting.

In addition, the DE layer can include API's (Application Programming Interfaces) to enable third parties to interact with the platform as needed to support partner relationships. The system design also can include the development of “public-ready” API's. The DE layer also can collect, store, process and manipulate data to support the decision making necessary to implement automated load control actions. The control/decision engine capability can support comprehensive control logic, math functions, scheduling, alarming, and event-based notifications enabling it to execute complex algorithms in order to execute load control decisions.

The DE layer can act as the central coordinator for the operation of the system. A system typically includes a single instance of an active DE application that is hosted by the energy manager. (There can be redundant DE applications that can take over for a previously active DE application if that application should cease to function properly.) The DE layer can include a web server for providing web pages which act as a user interface for the administrator. The DE layer can further store data that it uses to make decisions (e.g., by reading from a database of customers) and to request actions (e.g., by reading from a database of LCUs and their IP addresses). The DE layer can further communicate with the other layers using any agreed upon protocol (e.g., using oBIX). (oBIX is an extensible web services, XML-based protocol for communicating building operations data such as electrical consumption and load status. The base oBIX specification can be extended with a set of “contracts” that address the messaging used to support the functionality described herein.) The oBIX 1.0 Committee Specification 01, dated Dec. 5, 2006 (available via http://www.oasis-open.org/committees/obix) is hereby incorporated by reference.

The Load Control Unit (LCU) layer refers to the control device installed at the customer site that receives messages from the DE layer and executes load control actions by communicating with the on-site Building Automation System (BAS) or via direct control of outputs such as relays. Exemplary products that can be used in the LCU level/layer include, but are not limited to: (1) the WEPM and WEM from Energy Tracking LLC (targeted for use in smaller less complex applications) or comparable products and (2) the Tridium Niagara JACE 201, JACE 601 and SoftJACE for larger applications. The products differ in the amount/type of logic processing, the capacity and type of I/O offered and the information presentation capability offered in the local unit.

Exemplary features provided at the LCU layer include, but are not limited to, the following depending on the type of LCU unit selected: (1) Device communication interfaces to enable connectivity with external systems such as meters and BAS: LON, MODBUS, BACnet, Proprietary, DNP, OPC, Zigbee (and variants of 802.15.4), WiFi (e.g., the 802.11 family of protocols), and WiMax. Physical Inputs and Outputs for direct monitoring and control of loads or for providing load control signals to less sophisticated building control systems can include pulse inputs, analog inputs, digital outputs, analog outputs. The LCU layer may additionally include real-time control engine/decision making capability (e.g., IF/THEN logic, scheduling, math capability, alarming, notifications).

The LCU layer typically is implemented as locally hosted software in each facility (e.g., building or buildings) to be controlled, with one or more LCU instances per facility. An LCU layer can be implemented to include a web server which provides a web interface for interactions with the LCU. Other interfaces for interacting with the LCU are also possible, such as a desktop tool (e.g., in contexts where a web browser does not have the necessary user or communications interface for dealing with an LCU). The LCU can communicate with users or other applications, as described herein. For example, the LCU may provide to an administrator an interaction mechanism (e.g., a set of web pages) used to install and commission a LCU to bring a facility online into the program (for example, by integrating the LCU with the BAS and defining the model of electrical loads and control scenarios). The LCU is also used to interface with the building automation systems such that the LCU encapsulates or hides the heterogeneity of BASs from the DE layer. The LCU can communicate with the DE layer using any number of agreed upon protocols (e.g., using oBIX).

By communicating with the software that controls the building automation systems (BASs) (rather than communicating with the equipment directly), interface time can be reduced and the existing logic/rules controlling the equipment can be utilized to ensure proper control of the equipment. For example, if equipment has an existing control interface (e.g., that ensures that a particular area never gets above or below a specified threshold), the system, by communicating with existing control interface, ensures that this rule is always satisfied (whereas the rule might not be satisfied if it was inadvertently not conveyed to the energy manager during system design time).

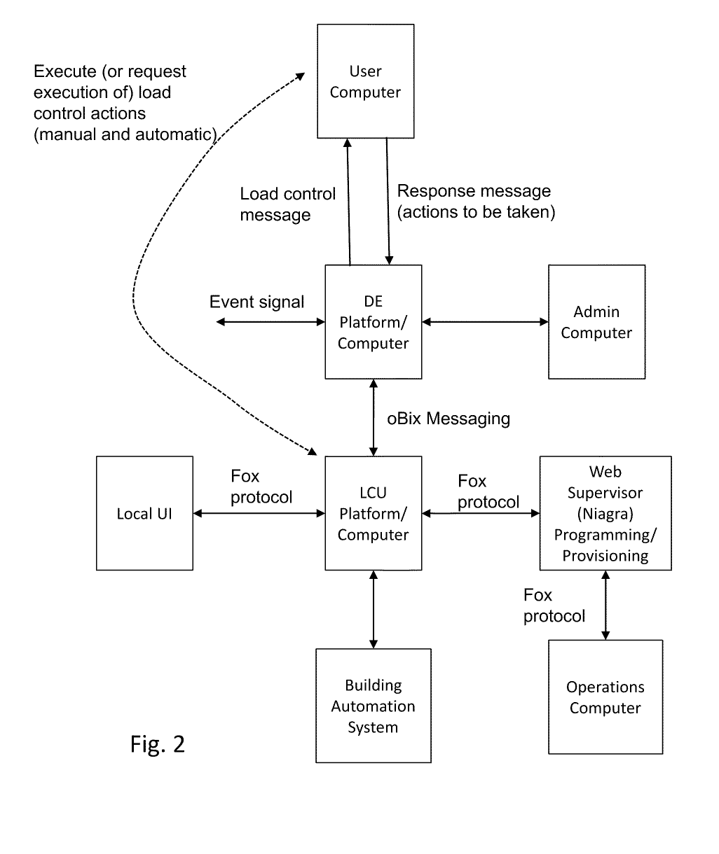

Turning to FIG. 2, a block diagram shows the interaction between various computers operating at the different logical levels described above with respect to FIG. 1. As shown therein, in addition to communications between layers using a first protocol (e.g., oBIX), communication can be made with other computers (or between levels) using at least a second protocol (e.g., a Fox protocol). For example, enterprise interfaces (e.g., oBix (Open Building Information Exchange), Fox (commissioning protocol for Tridium Niagara devices), BACnet, OPC Server) for integration with external applications may also be included in the LCU layer as can user interface generation (e.g., locally served browser-based user interface providing (1) real time information displays using animated widgets, reporting using charts and tabular displays and (2) notifications using email and SMS messaging techniques).

By utilizing those three logical levels/layers (but understanding that some of the functionality may be moved to a different layer than described herein or replicated in multiple layers), the system can provide coordination to achieve the exemplary energy reduction goals described herein. Such exemplary goals include, but are not limited to: (1) Fully automated control of customer loads, (2) Highly refined control capability, (3) User adjustment and acceptance of participation in events and (4) Reporting to an energy manager on planned load shed participation and actual participation.

Each of those goals provides at least one benefit. For example, fully automated control of customer loads eliminates the need for the customer to manually manage loads and/or reduces the risk of non-compliance/non-participation when events occur. Similarly, by having a highly refined control capability, as opposed to simplistic on/off load control offerings that typically shut off major pieces of equipment, the system will interact with existing building automation systems to minimize the affect of load control on customer operations and maximize demand reduction. In addition, this approach will minimize the amount of equipment that needs to be installed in a customer site to achieve successful load control response.

In order to provide user adjustment and acceptance of participation in events, the system may provide a web-based GUI that will allow the user to see the dollar value of participating at a requested load shed level and the dollar value impact of participating at an alternate (typically lower) level of load shed. The customer will then be able to select their desired level of participation, the load control actions that will use to achieve that level, and in doing so inform an energy manager as to their planned participation. Similarly, by reporting to the energy manager on planned load shed participation and actual participation, the system will allow the energy manager's operations to be informed in near real time of customer commitments to shed load in response to a request. After load control events the system will report the actual load shed level achieved to the energy manager as well as to the customer.

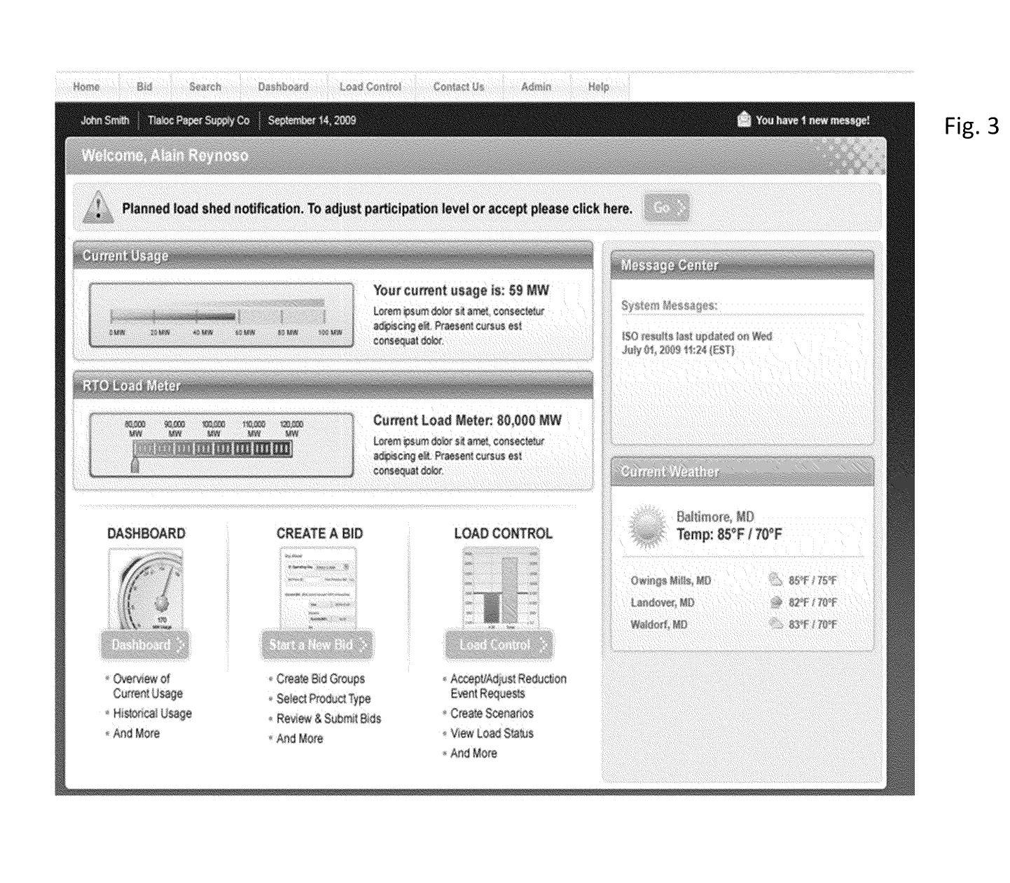

To achieve one or more of the above-described functions, the system can cause the Decision Engine (DE) to send an automated, electronic event notification (e.g., a load control event message) to a user computer associated with a customer, as shown in FIG. 2. (Such messages can be in the form of email, display of information on a browser screen (as shown in FIG. 3), SMS, manual notification via phone, etc.) After having selected one of the possible responses to the load control event message, the user's computer can signal to the DE what actions are going to be taken (or have been taken) in response to the load control event message. The user computer also may respond to the LCU to request that the corresponding load control actions be taken on the customer's behalf The customer may also take manual action and report to the system (e.g., the DE or the LCU) that such action has been taken.

As part of the event notification, the system may provide the user feedback on the monetary value of participating in the event, and where applicable, customer adjustment of requested load shed amount with feedback on the monetary impact of the adjustment. To be able to respond to the event notifications, the system can provide various load control capabilities, including, but not limited to: (1) automated adjustment of variable operating parameters (e.g., temperature setpoints, pressures, flow rates), and (2) control of individual loads including (a) initiation of equipment “duty cycling”, “load shifting” and “hold off” strategies and (b) support for dispatch of local generation where applicable, as described in greater detail below.

In addition, the system can provide exemplary information management features, including, but not limited to: (1) a consumption “speedometer” (e.g., a gauge showing a monitored consumption rate as shown in FIG. 3), (2) tracking and reporting of Key Performance Indicators (KPIs) (e.g., commodity/sq ft/degree day, commodity/tenant/group/category/sq ft/degree day, color gradient for performance, power quality, on-site gen availability/control, uninterruptable Power Supply monitoring, carbon footprint calculation), local marginal pricing, future pricing, actual pro-forma bill on customer-selected billing cycle, weather history report, drill downs on individual meters and submeters, notifications and messaging (e.g., as are available via Twitter feed/social networks, SMS), customized reporting of all monitored data including control level (DR level) selection, support for multiple commodities, carbon footprint tracking and carbon trading (future), tenant/lobby kiosk integration, tracking support for use of green power, and inventory/contract/settlement reporting (e.g., contract elements, pricing, share of ISO payment, amount of time an on-site generator can be used, contractual obligations for response—“what they signed up to do”, shadow settlement based on data collected via M&V, payments history and report showing the monetary benefit of the program to the customer to-date).

By utilizing a monitored control system as described herein, a customer may obtain various benefits with respect to its energy consumption. For example, by utilizing automated load control/demand response, a customer can participate in demand response programs (e.g., PJM Synch Reserve, ERCOT LaaR (Load acting as Resource)) that will enable the customer to save money and to help reduce energy consumption in times of peak demands. Furthermore, by using fine-grain control of loads instead of just turning off major loads, capacity can be reduced more efficiently, reducing the affect on building operations and occupant comfort. Load shaping also enables the customer to buy a “better” commodity product, and the customer can get visual feedback by using a dashboard-style control that provides real time energy, operational and financial information.

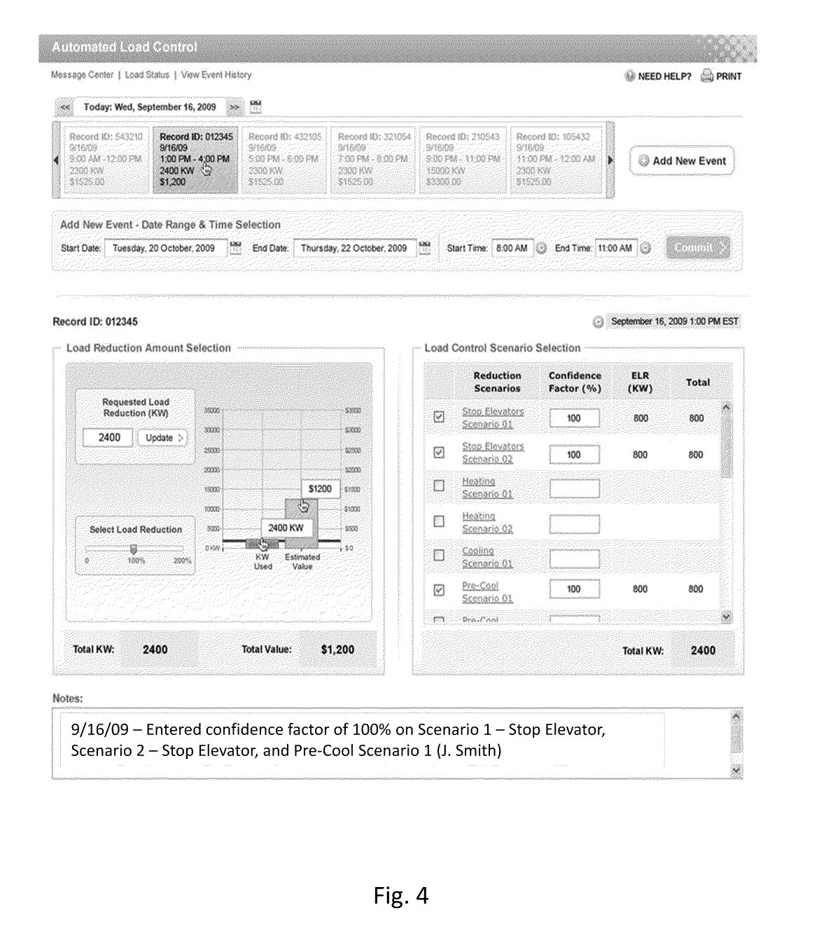

The visual feedback likewise extends to the ability to select the level of participation in DR events (where applicable), often by utilizing technology already installed in the building that currently changes the building operations. For example, as shown in FIG. 4, a user interface can include a “Load Reduction Amount Selection” section which shows a bar at the specified new load level of 2400 KW (left bar) which generates an estimated savings of $1200 (right bar). The effects of load reduction can be further seen using either the “Requested Load Reduction (KW)” text box and its associated update button or the “Select Load Reduction” slider bar. The Decision Engine may provide the estimated costs savings to the user's user interface based on the DE's internal estimate algorithm which may use factors such as: Consumed Power factors (e.g., power source cost (green power, on-site generation), power rate limit (max and min) MW, capacity available (power limit) MWH, cost of power $ MW and quantity of power requested (MW reduction over a duration of time)); Time factors (e.g., Time of day, Speed of curtailment response); Production Constraints (e.g., Production schedule, Limit # of hours curtailed per season, Comfort level (production quality), Contractual condition, Customer power purchase price, Profit of production, Environmental conditions and Safety factors); Energy Manager Constraints (e.g., ISO obligations, Portfolio obligations, Purchase power agreements, and Purchase price from the market), Load control authority (who has the authority to adjust the requested load control and who can override by how much and when they can do it. For example, the user may be allowed to adjust the requested amount by 10% or 50%)); Environmental (e.g., Carbon impact, Emissions impact, Green power and Social constraints). As further shown in FIG. 4, the User may utilize checkboxes to select one or more scenarios from a set of pre-specified reduction scenarios, each with corresponding load reduction amounts (which may be automatically totaled by a user interface). Preferably the system shows availability of identified loads/control parameters, including both override and “it's not running” to allow a customer to see what load can and cannot be shed.

Once a user is satisfied with the reduction to be made, the user can specify the time period for the reduction (if it has not already been automatically entered into the user interface from the load control event message) and select the “Commit” button. Customers may also be attracted to other factors that are achieved via such a response system including lower costs for energy, social responsibility benefits from reducing energy consumption and improved management and/or building operations through tracking and reporting of Key Performance Indicators.

The energy manager also benefits from customer participation. For example, advanced load control capability enables an energy manager to create and offer a more accurate price responsive commodity product. Further, real time consumption data can be utilized in a variety of ways (e.g., to manage risk, allocate budgets, and evaluate capital improvements). Additionally, since the customers can respond to load control events in times of need, they can also respond to load control events in times of market opportunities. For example, real time pricing (independent of an ISO event) may provide the energy manager (in cooperation with customers) to reduce load and resell the resulting power at a significant markup. End-to-end real time communication and control also allow an energy manager to shape load. As described above, using finer grain control, an energy manager can provide customers with a Demand Response offering that has less impact to operations and occupant comfort than compared to the effects of only using changes to major loads. The comprehensive decision engine software platform even can be used with other partners and local control technologies depending on business opportunities.

To facilitate the operation of the system as described above, the system relies on the LCU layer to provide the necessary set of control interfaces such that energy usage can be controlled according to one of a number of possible control scenarios/techniques. One such set of control interfaces includes, but is not limited to, Tridium's Niagara Web Supervisor software and Niagara Workbench software. Using such interfaces, local control algorithms can implement load control in response to messages from the DE layer. Core functions to support the core set of load control actions needed, include, but are not limited to: turn load OFF, turn load ON (e.g., generator), adjust control parameter (e.g., temperature setpoint, maximum capacity of a variable speed fan) and setting/changing duty cycling of loads. Such core functions can be assembled based on the unique requirements and load control opportunities of individual sites. The levels of customization may vary for individual projects/sites/equipment.

The messaging structure between the DE and LCU may be implemented using a number of protocols (e.g., oBIX (open Building Information eXchange), a standard web service protocol developed under the OASIS standards body (www.oasis-open.org), or XML). Exemplary software may be used on both the LCU and DE to implement this messaging (e.g., using the Niagara-based JACE hardware platform). Generally, customization can be performed to adapt the protocol to any LCU platform.

It is possible to handle load control event initiation (the ISO service that calls for the DR response) either manually or automatically, depending on the sophistication of the system. In a manual system, a human responds to an ISO event call and then initiates the electronic messaging to the LCU to inform the customer and start the load control event. In an automated process, a series of rules and parameters (e.g., stored in a database) are used to automatically respond to an ISO event call and then initiate the electronic messaging to the LCU to inform the customer and start the load control event.

At the UI layer, user interface screens can provide information to a customer on a real-time basis and/or allow the user to select past events and see all relevant parameters of the event as it was committed by the user. For example, the user interface may show (1) pending event call notifications (as shown in FIG. 3) (e.g., with a monetary value to the user presented (where applicable)), (2) Real time display of current load (as shown in FIG. 3) and dynamic trend graphs showing load profile and KW/KWH/KVAR values over time, (3) a log of an entire event cycle with its corresponding details (e.g., request received, acceptance with any adjustments made, load value throughout entire day of operation), (4) a report of (a) historical load/consumption data (along with any corresponding load reduction events that occurred at that time) for historical reporting and analysis and (b) future predicted loads and energy reductions events (both confirmed or awaiting confirmation) (as shown in FIG. 4 as a “ribbon bar” showing a series of events in a scrolling window), (5) basic history reports of load and consumption, (6) an indication of whether or not a load shed goal was achieved, and (7) metering data. In one embodiment, all data is logged and maintained in the DE platform, and reports are run off of the data stored in the DE platform. When utilizing a ribbon bar, as in FIG. 4, the user can navigate the ribbon bar to select the time period they want to view or interact with. The width of the load control request can be proportional to the period of time the individual load reduction request is for. For example, in the ribbon bar, one request might be an hour wide and another might be 4 hours wide. The user will be able to scroll forward to future hours or future months as needed by their contract/situation (e.g., to see pending load control event messages and/or estimated usages). Periods with pending load control event messages may be displayed in a fashion to attract attention (e.g., using a different color and/or font).

As described above, various applications communicate using various protocols. In at least one embodiment of the communication described herein, at least a portion of the communications are encrypted (e.g., using HTTPS or a secure shell). In addition, authentication of users and/or administrators can be required by the system to ensure that only authorized users interact with the system.

As described above, load reduction messages can be sent to customers in order to request a selection of a load reduction response. In one embodiment, the message takes the form of a request for a reduction to an absolute, specified amount (e.g., expressed in kilowatts or megawatts) at a particular time. In another alternate embodiment, the message may instead request a change by a relative amount (e.g., expressed as a percentage change or an amount of a change (e.g., a decrease of a specified KW or MW)). In yet another alternate embodiment, the message may instead request that the customer not exceed a new target maximum usage (e.g., expressed in KW or MW). In a further alternate embodiment, the message may instead request the implementation of at least one specific scenario (e.g., “Stop Elevators Scenario 1” or “Stop Elevators Scenario 2” are both good candidates for a known amount of savings since they both have 100% confidence factors) pre-specified by the customer. In another embodiment, a message may be sent that is instead a query, rather than a request, to determine whether a recipient can commit to a particular reduction for a particular amount of time during any portion of a specified period. For example, the system may query whether there is a 4 hour period anytime during a specified period (e.g., 24 hours or week) during which the user can commit to the specified set of load conditions (e.g., less than a maximum energy usage or reduction of a particular amount over a previously estimated level).

Scenarios are built up of groups of data (e.g., a database row) representing (1) at least one load, (2) a load control action, (3) the KW reduction associated with each load of the at least one load, and (4) at least one link to connect to and control the at least one load. (The KW reduction may be determined by empirical testing or by manufacturer data depending on the needs of the specific application and the KW value of the load.) Thus, one or more groups of data can be combined together to create a load control scenario that the user can select (e.g., with a checkbox as shown in FIG. 4). Preferably, the system includes a user interface for allowing customers (with sufficient authorization) to see the information associated with the groups of data corresponding to any of the customer's scenarios and to create new scenarios (e.g., by specifying groups of data that are to be used together in the new scenario). New scenarios may be named using a customer-specific naming convention. The user will be able to see any text description associated with a scenario to provide more information on the scenario.

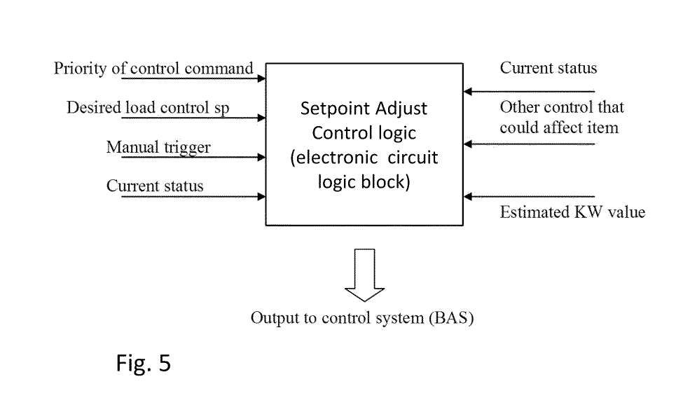

As shown in FIG. 5, the system can utilize logic blocks implemented as electrical circuits for implementing control signals to be sent to a Building Automation System (BAS) based on a series of inputs in order to control the system (e.g., by implementing the control signals required to achieve various scenarios). The logic blocks (including all control functions described herein including the individual computer systems of FIG. 1) can be implemented as: (1) a processor (e.g., an embedded or discrete processor) and its (embedded and/or discrete) computer memory, where the processor reads and executes a series of computer instructions stored in the computer memory, (2) a programmed logic device (potentially with associated computer memory) that is configured (e.g., in the case of discrete components (e.g., interconnected resistors, capacitors and inductors), an ASIC or one-time programmable logic circuits), (3) a reprogrammable logic device (potentially with associated computer memory) that is (re)programmed (e.g., in the case of a FPGA or GAL) to provide the desired outputs for a set of specified inputs, or (4) a combination of (1), (2) and/or (3). All four such configurations are referred to herein as “electronic circuit logic blocks.” Moreover, “electronic circuit logic blocks” can be either built separately or grouped together to form larger groups of “electronic circuit logic blocks.”

The system may also determine that an automatic load control (ALC) event may have been addressed or may no longer be needed. In such a case, the system can inform at least some of the customer systems that they can return to a normal operating state. For example, if the system determines that customers have responded such that more energy is going to be reduced than was needed, the system may inform a number customers that they can recommence their operations up to a level that keeps the system below a desired threshold. Turning to the example of FIG. 4, if a system determines that customers have agreed to shed 2000 kW more than necessary, the system may send a customer a notification that “Stop Elevators Scenario 1” and “Pre-Cool Scenario 1” can be canceled because their estimated usage is 1600 kW, thereby staying below the excess 2000 kW. Alternatively, the system may send a customer a notification that it can restart up to 1800 kW (so that there is margin for error with the 2000 kW estimated overage), and the application of the customer may select which selected scenarios to cancel.

Preferably the local system records and logs all actions related to load control operations (e.g., the selection of a scenario, the acceptance of a load control event (including a shed amount and its associated monetary value), and all actions involved in the execution of the load control response (e.g., setpoint changes, load status, and the current status at the time of the event execution).

Preferably prior to committing to any action in response to a load reduction event the system verifies end to end system availability such that the system is sure it can communicate with the BAS that will affect the final control of the loads. Audits or logs may be to checked to verify that the expected load reduction results are generated.

In addition to controlling energy usage of energy received from an external energy source (e.g., the electrical grid), a system according to the present invention can utilize local and/or alternate energy sources. For example, if an energy manager sends a request to reduce energy consumption, a local controller can switch to one or more local sources of energy (e.g., solar power, battery, or electricity from a local gasoline- or natural gas-powered generator) instead of reducing energy consumption or in addition to reducing energy consumption. The system may utilize estimates of costs to switch to those sources and provide to a customer a recommendation on how to respond to the request to reduce energy from the energy manager.

As described herein, a customer responds to pending load control event messages after their receipt. The period for responding to such messages may be specified (e.g., in the messages themselves or by agreement between the customer and the energy manager). In the event that a customer does not respond to such a message in the specified period, the system may automatically cause certain scenarios to be implemented in an order pre-specified by the customer in order to ensure that the customer meets its obligations to the energy manager.

While certain configurations of structures have been illustrated for the purposes of presenting the basic structures of the present invention, one of ordinary skill in the art will appreciate that other variations are possible which would still fall within the scope of the appended claims.

We claim:

1. A system for providing a customer response to an automatic load control event, the system comprising:
a first electronic circuit logic block for receiving a load control event message;
a second electronic circuit logic block for generating a display for a customer including a set of plural load control scenarios that can be selected to respond to the load control event message;
a third electronic circuit logic block for generating a display for the customer of an amount of reduction associated with selected load control scenarios of the plural load control scenarios that were selected in response to the load control event message; and
a fourth electronic circuit logic block for sending an electronic commitment message identifying an amount the customer will reduce a load at a time specified in the load control event message.

2. The system as claimed in claim 1, wherein the second electronic circuit logic block comprises a fifth electronic circuit logic block for generating a user interface including a set of checkboxes for specifying the set of plural load control scenarios that can be selected to respond to the load control event message.

3. The system as claimed in claim 1, wherein the second electronic circuit logic block comprises a fifth electronic circuit logic block for generating a user interface including a slider bar for specifying an amount of reduction to be made in response to the load control event message.

4. The system as claimed in claim 2, wherein the interface comprises a browser interface.

5. The system as claimed in claim 3, wherein the interface comprises a browser interface.

6. The system as claimed in claim 2, wherein the third electronic circuit logic block further comprises a sixth electronic circuit logic block for generating a display for the customer of a monetary value of the amount of reduction associated with the selected load control scenarios of the plural load control scenarios that were selected in response to the load control event message.

7. The system as claimed in claim 3, wherein the third electronic circuit logic block further comprises a sixth electronic circuit logic block for generating a display for the customer of a monetary value of the amount of reduction associated with the selected load control scenarios of the plural load control scenarios that were selected in response to the load control event message.

8. The system as claimed in claim 6, wherein at least one of the first through sixth electronic circuit logic blocks are implemented as a programmable logic block.

9. The system as claimed in claim 7, wherein at least one of the first through sixth electronic circuit logic blocks are implemented as a programmable logic block.

10. A method of providing a customer response to an automatic load control event, the method comprising:
receiving, at a first electronic circuit logic block, a load control event message;
generating, at a second electronic circuit logic block, a display for a customer including a set of plural load control scenarios that can be selected to respond to the load control event message;
generating, at a third electronic circuit logic block, a display for the customer of an amount of reduction associated with selected load control scenarios of the plural load control scenarios that were selected in response to the load control event message; and
sending, from a fourth electronic circuit logic block, an electronic commitment message identifying an amount the customer will reduce a load at a time specified in the load control event message.

11. The method as claimed in claim 10, further comprising generating, at a fifth electronic circuit logic block, a user interface including a set of checkboxes for specifying the set of plural load control scenarios that can be selected to respond to the load control event message.

12. The method as claimed in claim 10, further comprising generating, at a fifth electronic circuit logic block, a user interface including a slider bar for specifying an amount of reduction to be made in response to the load control event message.

13. The method as claimed in claim 11, wherein the interface comprises a browser interface.

14. The method as claimed in claim 12, wherein the interface comprises a browser interface.

15. The method as claimed in claim 11, further comprising generating, at a sixth electronic circuit logic block, a display for the customer of a monetary value of the amount of reduction associated with the selected load control scenarios of the plural load control scenarios that were selected in response to the load control event message.

16. The method as claimed in claim 12, further comprising generating, at a sixth electronic circuit logic block, a display for the customer of a monetary value of the amount of reduction associated with the selected load control scenarios of the plural load control scenarios that were selected in response to the load control event message.

17. The method as claimed in claim 15, wherein at least one of the first through sixth electronic circuit logic blocks are implemented as a programmable logic block.

18. The method as claimed in claim 16, wherein at least one of the first through sixth electronic circuit logic blocks are implemented as a programmable logic block.
